(19) United States
(12) Patent Application Publication
(10) Pub. No.: US 2025/0002128 A1
(43) Pub. Date: Jan. 2, 2025

(54) Boat Lift Drive With Integrated Sensor

(71) Applicant: Lake Lite, Inc., Fort Wayne, IN (US)

(72) Inventor: Jeff MARTZALL, Fort Wayne, IN (US)

(73) Assignee: Lake Lite, Inc., Fort Wayne, IN (US)

(21) Appl. No.: 18/758,490

(22) Filed: Jun. 28, 2024

Related U.S. Application Data
(60) Provisional application No. 63/511,393, filed on Jun. 30, 2023.

(51) Int. Cl. B63C 3/06; B66D 1/12; B66D 1/48

(52) U.S. Cl. CPC B63C 3/06; B66D 1/12; B66D 1/485

(57) ABSTRACT

A boat lift winch drive with a sensor or method of sensor engagement that is designed to determine the revolutions, position, speed and direction of the winch shaft is disclosed. The sensor may be incorporated into the winch drive that attaches to the winch shaft. The sensor may be located after the motors gear reduction and at the winch drive and winch shaft to allow for less expensive electronics and components to be used, reducing the cost of controls required to reduce the motor speed before reaching the intended stopping point.

### CROSS REFERENCE TO RELATED APPLICATIONS

The current application claims priority to U.S. Provisional Application No. 63/511,393 filed Jun. 30, 2023 the disclosure of which is incorporated herein by reference in its entirety.

### TECHNICAL FIELD

This invention relates to boat lifts in general, and, more particular, sensors and related equipment for boat lift winch drive mechanisms capable of determine the revolutions, position, speed, and direction of the winch shaft being driven by the drive as well as improvements thereto.

### BACKGROUND

The general desirability of boat lift winch motors is well known. First and foremost, adding a motor to a boat lift can save the operator time and effort. With a manual boat lift, a hand crank or winch is needed to lift the boat out of the water, which can be a physically demanding and time-consuming task. With a boat lift motor, an operator can lift and lower the boat with the push of a button, making the process quicker and easier.

In addition to saving time and effort, a boat lift motor can also help to protect the boat. When a manual lift/crank/winch is used, there is a risk of raising and/or lowering the lift too far or too quickly. A motorized boat lift can help to eliminate these risks by providing a smooth, controlled lift.

Another benefit of a boat lift motor is that it can help to extend the lifespan of the boat lift. When manually lifting a boat, there is a greater risk of wear and tear on the lift mechanism. A motorized lift, on the other hand, is designed to be more durable and long-lasting, which can help to prevent damage and reduce the need for repairs or replacement parts.

In addition to the benefits of having a boat lift motor on a manual boat lift, there are also advantages to having a motor that has programmable up and down limits. First, this feature allows an operator to set precise limits on how high and low the lift can go, which can help to prevent damage to the boat or the lift itself. Programmable limits can help ensure that a boat is lifted to the exact height needed for safe and easy storage.

Furthermore, a motor with programmable limits can be especially useful in situations where there are varying water levels or tide conditions. By setting specific limits, an operator can ensure that the boat lift is always functioning optimally, regardless of changing water levels. Additionally, programmable limits can also be beneficial for safety purposes. By setting upper and lower limits, an operartor can prevent the lift from accidentally exceeding its lifting range, or hitting obstructions, which can help to avoid accidents, damages, or injuries to the boat, boat lift, or persons operating the lift.

Boat lift winch drive mechanisms and adapter mechanisms for adapting manual winches to being driven by motors are also well-known as well and have been used for many years by owners of boat lifts who do not wish to operate boat lift winches manually. Examples of various devices and mechanisms used in the past and prior art hereto include the following patents, the contents of which herein fully incorporated by reference. U.S. Pat. No. 8,196,899 discloses a spline adapter for a boat winch drive shaft that threads onto the winch shaft and then the adapter has a spline tooth shape on the outside that fits a spline shaped gearbox having a wormdrive arrangement. U.S. Pat. No. 7,784,767 discloses an adapter that threads onto the boat winch drive shaft and then the adapter also has exterior threads that fit into a threaded gearbox having a wormdrive arrangement. U.S. Pat. No. 10,287,146 discloses an adapter that threads onto the winch shaft and then the adapter has a tapered fit to fit into a tapered gearbox having a wormdrive arrangement.

However, none of these prior art patents/disclosures related to boat lifts, boat lift winch adapters, or boat lift drive mechanisms tha disclose a sensor and related equipment, including an electronic circuit, to determine the revolutions, position, speed, and direction of the winch shaft being driven by the drive mechanism for the advantageous purpose of being able to independently determine, without operator intervention or input, the more or less exact position of the boat lift at any point in time, the history of the movements thereof, and which is also capable of providing such information to an operator, even remotely, if so desired.

### SUMMARY

In a first aspect of the present disclosure, the present invention comprises a winch drive that includes a sensor or sensor engagement method for use by an electronic circuit to determine the revolutions, position, speed, and direction of the winch shaft being driven by the drive. In an advantageous embodiment thereof, the sensor is placed at the winch shaft adapter, rather than the motor shaft, because the speed of the winch shaft and winch shaft adapter is typically slower than the motor shaft due to gear reductions placed on the motor.

A sensor on the winch shaft or motor shaft is preferable to using a sensor inside the motor as the motor is turning very fast. Stopping the motor at the exact revolution count is troublesome as the motor will often keep rotating until inertia comes to a stop. To stop the motor at the correct count would require costly controls such as PWM circuit or similar to reduce the motor speed before reaching the intended stopping point. By placing the sensor at the slower output shaft after the motor gearbox, less expensive electronics and components can be used.

Sensors useful for incorporation in the invention of the present disclosure include, but are not limited to hall-type sensors, proximity sensors, optical sensors, encoders, or other types of sensors as are known to those of ordinary skill in the art. The drive may be an attachment assembly to the winch shaft or a replacement shaft assembly for integration directly into the winch. More specifically, embodiments of the invention would include utilizing an adapter assembly for the winch shaft which threads onto the existing winch shaft or replacing the winch shaft with an entirely new shaft assembly that incorporates aspects of the present disclosure. In general, if the existing winch shaft may be easily removed and replaced by the user, a replacement winch shaft assembly is preferred over the adapter assembly as it eliminates one potential source of wobbles and/or failures, namely threading of the adapter assembly onto the existing winch shaft.

These and other features and advantages of the present invention will become apparent to those skilled in the art upon consideration of the following detailed description of preferred embodiments exemplifying the best mode of carrying out the invention as presently perceived.

### BRIEF DESCRIPTION OF THE DRAWINGS

FIG. 1 is an exploded side perspective view of an exemplary boat winch and boat winch motor and controller assembly incorporating aspects of the current disclosure;

FIG. 2 is a side perspective detail view of the boat winch and boat winch motor and controller assembly of FIG. 1;

FIG. 3 is a side perspective detail view of the boat winch and boat winch motor and controller assembly of FIG. 1 showing an alternate embodiment of the drive holding washer as a sprocket;

FIG. 4 depicts exploded side perspective views of winch shaft adapter assemblies of embodiments of the current disclosure;

FIG. 4A is an exploded side perspective view of a winch shaft adapter assembly of an embodiment of the current disclosure;

FIG. 4B is an exploded side perspective view of a winch shaft adapter assembly of an alternate embodiment of the current disclosure showing the drive holding washer as a sprocket;

FIG. 4C is an exploded side perspective view of a winch shaft adapter assembly of an alternate embodiment of the current disclosure showing a sprocket integrated into the adapter assembly;

FIG. 4D is an exploded side perspective view of a winch shaft adapter assembly of an alternate embodiment of the current disclosure showing a magnet integrated into a head portion of the adapter assembly;

FIG. 4E is a side perspective view of a winch shaft adapter assembly of an alternate embodiment of the current disclosure showing a magnet integrated into the drive nut of the adapter assembly;

FIG. 4F is a side perspective view of a winch shaft adapter assembly of an alternate embodiment of the current disclosure showing a sensor bore integrated into a head portion of the adapter assembly;

FIG. 4G is a side perspective view of a winch shaft adapter assembly of an alternate embodiment of the current disclosure showing a sprocket integrated into the drive nut of the adapter assembly;

FIG. 5 depicts exploded side perspective views of winch shaft replacement assemblies of embodiments of the current disclosure;

FIG. 5A is an exploded side perspective view of a winch shaft replacement assembly of an embodiment of the current disclosure showing a magnet located on the drive holding washer;

FIG. 5B is an exploded side perspective view of a winch shaft replacement assembly of an alternate embodiment of the current disclosure showing the drive holding washer as a sprocket;

FIG. 5C is a side perspective view of a winch shaft replacement assembly of an alternate embodiment of the current disclosure showing a sensor bore integrated into a head portion of the winch shaft replacement assembly;

FIG. 5D is a side perspective view of a winch shaft replacement assembly of an alternate embodiment of the current disclosure showing a sensor bore integrated into the drive washer of the winch shaft replacement assembly;

FIG. 5E is a side perspective view of a winch shaft replacement assembly of an alternate embodiment of the current disclosure showing a magnet integrated into the drive washer of the winch shaft replacement assembly; and

FIG. 5F is a side perspective view of a winch shaft replacement assembly of an alternate embodiment of the current disclosure showing a sprocket integrated into the drive washer of the winch shaft replacement assembly.

### DETAILED DESCRIPTION

According to aspects of the invention, a mechanism for use with a boat lift winch drive that detects the revolutions, position, speed and direction of the winch shaft may be provided. In accordance therewith, the mechanism may include a sensor assembly including a sensor which may be placed on the winch shaft adapter assembly or on the winch shaft itself, since the speed of the winch shaft (due to gearing) is typically slower than the motor shaft. The slower speed at the winch shaft or winch shaft adapter assembly allows for less expensive electronics and components to be used, as compared to placing the sensor at or on the faster motor shaft. The present disclosure may include telecommunication or Bluetooth equipment allowing the position and/or movements of the boat lift to be monitored remotely if desired.

In accordance with aspects of the disclosure, a winch shaft adapter may be used and may have a sensor may include a hall sensor, optical sensor, laser sensor, proximity sensor, encoder, or other suitable sensor. The sensor may be connected to an electronic circuit that receives the signals generated by the sensor to determine the revolutions, position, and direction of the winch shaft. The electronic circuit may include a microprocessor or other suitable device that is programmed to process the signals generated by the sensor and provide control signals to the motor to control the operation of the winch shaft. The adapter may be an attachment to the winch shaft or a replacement shaft for the winch. Regardless, the sensor may be integrated into the adapter to detect the revolutions, position, and direction of the winch shaft.

The present invention provides several advantages over the prior art. By placing the sensor at the slower output shaft after the motor gearbox, less expensive electronics and components can be used. This reduces the cost of the controls required to reduce the motor speed before reaching the intended stopping point. Additionally, the present invention provides accurate detection of the winch shaft's revolutions, position, and direction, which can help to improve the safety and efficiency of the winch system.

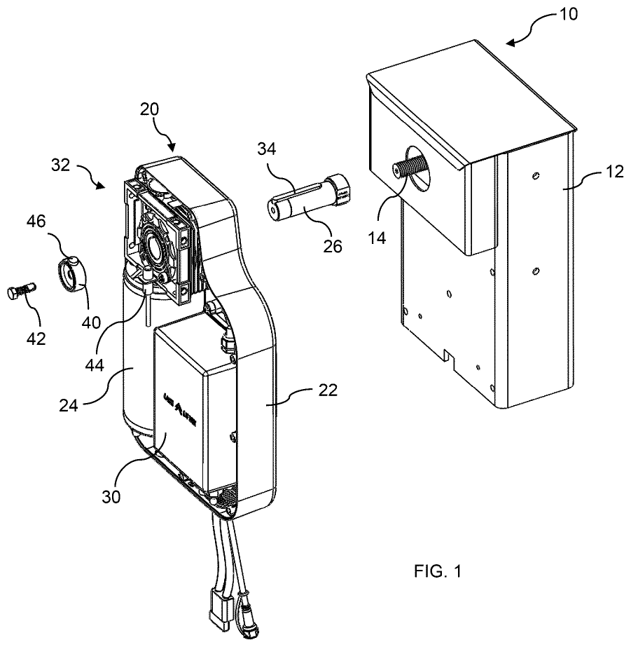

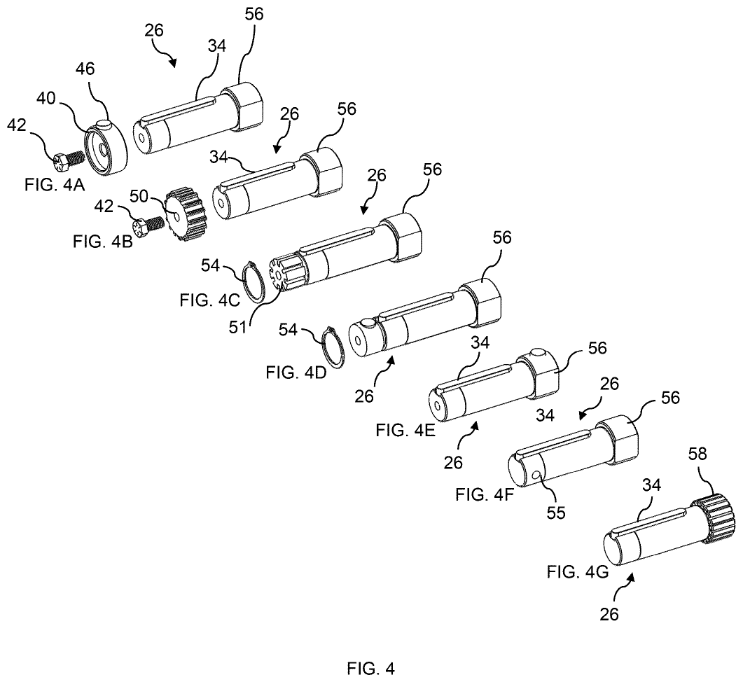

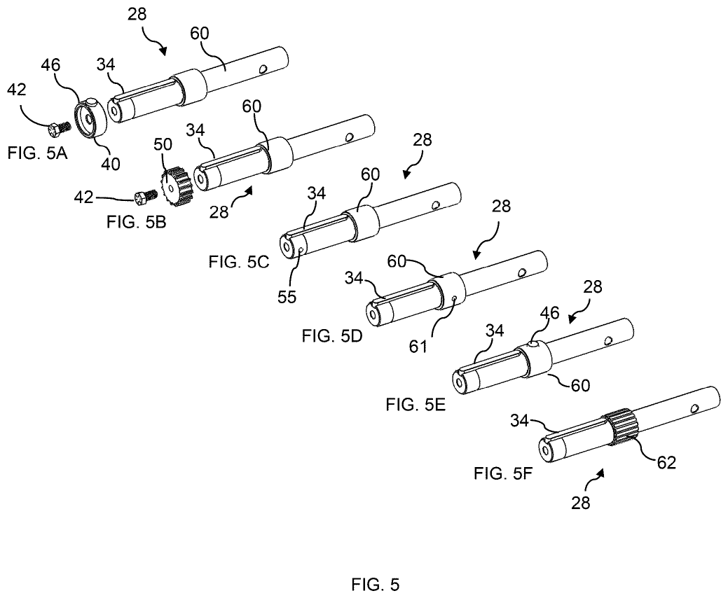

More specifically, as shown best in FIG. 1, in accordance with aspects of the present disclosure, a manual boat winch mechanism 10 may be housed in a winch housing 12 and include a winch shaft 14 protruding therefrom as is known in the art. Also as known in the art, a boat lift motor and controller unit 20 may be provided to power the winch mechanism 10 and be housed in a motor and controller housing 22. The boat lift motor and controller 20 may include a motor 24 for powering the winch mechanism 10, either through a winch shaft adapter assembly 26 (as shown in an exemplary manner in FIGS. 4A-4G) or a winch shaft replacement assembly 28 (as shown in an exemplary manner in FIGS. 5A-5E), and an electronic controller unit 30. The winch shaft adapter assembly 26, if used, is preferably threaded on the existing winch shaft 14.

The motor 24 may be connected to a gearing unit 32 which may use a worm gear and gearing (not shown) and be connected to the electronic controller unit 30 which controls the speed and gearing of the motor 24 to drive the winch mechanism 10 (either through the winch shaft adapter assembly 26 or winch shaft replacement assembly 28). The winch shaft adapter assembly 26 or the winch shaft replacement assembly 28 may include a spline 34 therein for keying into the gearing unit 32 to allow the winch mechanism 10 to be driven as desired.

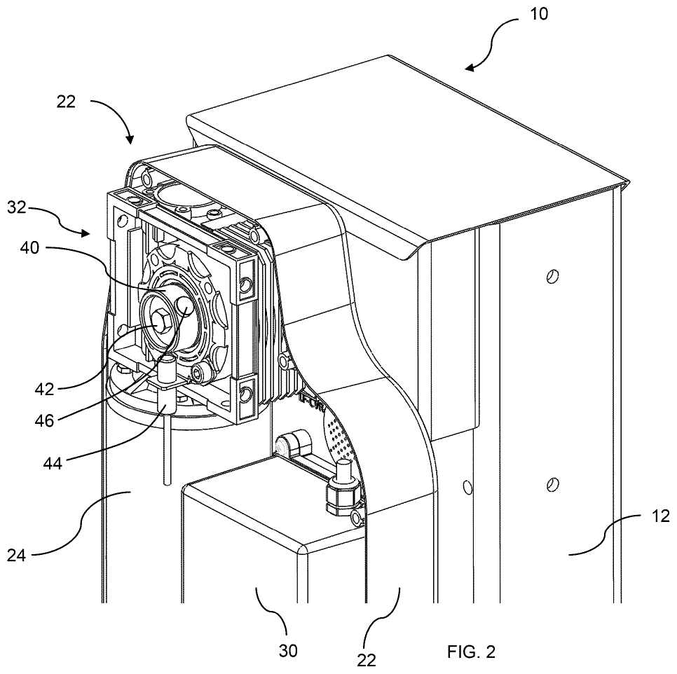

In aspects of the disclosure, as shown in FIG. 2, a drive holding washer 40 may be attached to the end of the winch shaft adapter assembly 26 or winch shaft replacement assembly 28 by a retaining both 42 and the boat lift motor and controller 20 may include a sensor unit 44 attached to the gearing unit 32 and being electronically connected to the electronic controller unit 30. The drive holding washer 40 may include a sensor indicator 46, such as a magnet, located thereon so that the movement thereof, namely the revolutions of the holding washer 40 (and thus the shaft adapter assembly 26/winch shaft replacement assembly 28) may be detected by the sensor unit 44 and relayed to the electronic controller unit 30. The electronic controller unit 30 may then use the corresponding revolution information to control the motor 24 to achieve the desired positioning of the boat lift (up or down). In this embodiment, the sensor unit 44 may be a Hall sensor.

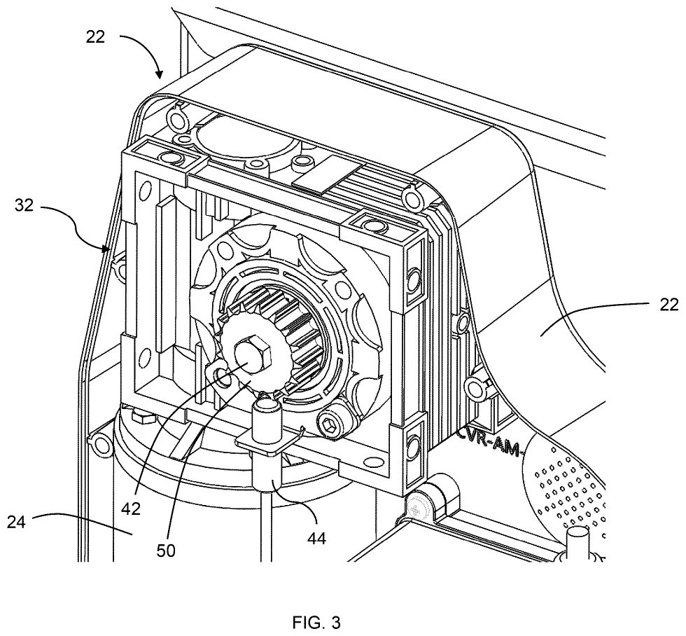

In alternate exemplary embodiments, the sensor indicator 46 may be comprised of alternate configurations. For, example, as best shown in FIG. 3, in one exemplary embodiment, the holding washer 40 may be replaced by a sprocket 50 and the sensor unity 44 may be configured to sense the revolutions of the sprocket 50 (and thus the shaft adapter assembly 26/winch shaft replacement assembly 28). In this embodiment, the sensor unit 44 may be a proximity sensor.

As best shown in FIGS. 4A-4G, embodiments of the present invention may be accomplished in multiple different manners and aspects when incorporated on a shaft adapter assembly 26. For example, FIG. 4A depicts the holding washer 40 having the sensor indicator 46 being a magnet and the sensor unit 44 being a Hall sensor. FIG. 4B depicts the holding washer 40 being replaced by a sprocket 50 and the sensor unit 44 being a proximity sensor. FIG. 4C depicts a sprocket 51 being directly incorporated into the end of the shaft adapter assembly 26 and having a washer 54 associated therewith. FIG. 4D depicts the sensor indicator 46 located directly on the end of the shaft adapter assembly 26 and having a washer 54 associated therewith. FIG. 4E depicts the sensor indicator 46 located on the drive nut 56 in which case the sensor unit 44 would be relocated in coordination therewith. FIG. 4F depicts the sensor indicator 46 being a through hole 55 located on an end of the shaft adapter assembly 26 in which case the sensor unit 44 could be a laser sensor, proximity sensor or the like. FIG. 4G depicts the drive nut 56 being replaced by a sprocket 58 in which case the sensor unit 44, such as a proximity sensor, would be relocated in coordination therewith.

As best shown in FIGS. 5A-5F, embodiments of the present invention may be accomplished in multiple different manners and aspects when incorporated on a shaft replacement assembly 28. For example, FIG. 5A depicts the holding washer 40 having the sensor indicator 46 being a magnet and the sensor unit 44 being a Hall sensor. FIG. 5B depicts the holding washer 40 being replaced by a sprocket 50 and the sensor unit 44 being a proximity sensor. FIG. 5C depicts the sensor indicator 46 being a through hole located on an end of the shaft replacement assembly 28 in which case the sensor unit 44 could be a laser sensor, proximity sensor or the like. FIG. 5D depicts the sensor indicator 46 being a through hole 61 located on the drive washer 60 on the medial portion of the shaft replacement assembly 28 in which case the sensor unit 44 could be a laser sensor, proximity sensor or the like and the sensor unit 44 would be relocated in coordination therewith. FIG. 5E depicts the sensor indicator 46 being a magnet located on the drive washer 60 on the medial portion of the shaft replacement assembly 28 in which case the sensor unit 44 could be a Hall sensor and the sensor unit 44 would be relocated in coordination therewith. FIG. 5F depicts the drive washer 60 being replaced by a sprocket 62 on the medial portion of the shaft replacement assembly 28 in which case the sensor unit 44, such as a proximity sensor, would be relocated in coordination therewith.

The various detailed embodiments described above are to be understood in the general context of the embodiments described herein. While each of the embodiments described above employs a particular combination of novel features, it is within the scope of the invention to provide compositions including combinations of said features not specifically described herein. While preferred embodiments of the invention have been set forth above for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A boat lift winch assembly comprising:
a boat lift winch having a winch shaft:
a motor for driving the winch shaft;
a sensor indicator operatively connected to the winch shaft;
a sensor unit configured to interact with the sensor indicator; and
an electronic control unit configured to receive data from the sensor unit such that the number of revolutions and speed of revolution of the winch shaft can be determined therefrom and operatively connected to the motor for controlling the operation thereof.

2. The boat lift winch assembly of claim 1 wherein the sensor indicator is a magnet.

3. The boat lift winch assembly of claim 1 wherein the sensor unit is a hall sensor.

4. The boat lift winch assembly of claim 1 wherein the sensor indicator is a sprocket.

5. The boat lift winch assembly of claim 1 wherein the sensor unit is a proximity sensor.

6. The boat lift winch assembly of claim 1 wherein the sensor indicator is a through hole.

7. The boat lift winch assembly of claim 1 wherein the sensor unit is a laser sensor.

8. An attachment for a boat winch assembly comprising:
a winch shaft adapter assembly configured to be securely connected to a winch shaft of a boat winch, the winch shaft adapter assembly having a sensor indicator operatively connected thereto, the sensor indicator being selected to interact with a sensor unit connected to an electronic control unit such that number of revolutions and speed of revolution of the winch shaft can be determined therefrom, the electronic control unit being operatively connected to a winch motor for controlling the operation thereof.

9. The attachment for a boat winch assembly of claim 8 wherein the winch shaft adapter assembly includes a drive holding washer attached to an end thereof and the sensor indicator is located on the drive holding washer.

10. The attachment for a boat winch assembly of claim 8 wherein the winch shaft adapter assembly includes a sprocket attached to an end thereof.

11. The attachment for a boat winch assembly of claim 8 wherein the winch shaft adapter assembly includes a sprocket attached to a base thereof.

12. The attachment for a boat winch assembly of claim 8 wherein the winch shaft adapter assembly includes a drive nut located on a base thereof and the sensor indicator is located on the drive nut.

13. The attachment for a boat winch assembly of claim 8 wherein the winch shaft adapter assembly includes a sprocket integrated into an end thereof.

14. An attachment for a boat winch assembly comprising:
a winch shaft replacement assembly configured to be securely connected to a boat winch assembly, the winch shaft replacement assembly having a sensor indicator operatively connected thereto, the sensor indicator being selected to interact with a sensor unit connected to an electronic control unit such that number of revolutions and speed of revolution of the winch shaft can be determined therefrom, the electronic control unit being operatively connected to a winch motor for controlling the operation thereof.

15. The attachment for a boat winch assembly of claim 14 wherein the winch shaft replacement assembly includes a drive holding washer attached to an end thereof and the sensor indicator is located on the drive holding washer.

16. The attachment for a boat winch assembly of claim 14 wherein the winch shaft replacement assembly includes a sprocket attached to an end thereof.

17. The attachment for a boat winch assembly of claim 14 wherein the winch shaft replacement assembly includes a sprocket attached to a medial portion thereof.

18. The attachment for a boat winch assembly of claim 14 wherein the winch shaft replacement assembly includes a drive washer located on a medial portion thereof and the sensor indicator is located on the drive washer.
